(19) United States
(12) Patent Application Publication
(10) Pub. No.: US 2016/0231977 A1
(43) Pub. Date: Aug. 11, 2016

(54) DISPLAY DEVICE FOR VEHICLE

(71) Applicant: YAZAKI CORPORATION, Tokyo (JP)

(72) Inventors: Yoshihisa YAMADA, Shizuoka (JP); Hidehiro AKAHORI, Shizuoka (JP)

(21) Appl. No.: 15/017,441

(22) Filed: Feb. 5, 2016

(30) Foreign Application Priority Data
Feb. 6, 2015 (JP) 2015-021973
Dec. 18, 2015 (JP) 2015-246998

(51) Int. Cl. G06F 3/14; G06F 3/0489; G06F 3/0485; G06F 3/0488

(52) U.S. Cl. CPC G06F 3/1454; G06F 3/0488; G06F 3/0489; G06F 3/0485

(57) ABSTRACT

A display device for a vehicle includes a connection unit configured to connect to a mobile terminal having a mobile display unit communicatively, a display unit configured to display a mobile display image to be displayed on the mobile display unit in a state where the mobile terminal is connected to the connection unit, a control unit configured to control display of the display unit, and an operation unit having a direction switch and a decision switch. The operation unit inputs an operation instruction according to a direction operation of the direction switch or a decision operation of the decision switch to the control unit. The control unit converts the operation instruction input from the operation unit into an operation signal corresponding to a touch operation for the mobile terminal and outputs the operation signal to the mobile terminal.

### CROSS REFERENCE TO RELATED APPLICATIONS

This application is based on Japanese Patent Application (No. 2015-021973) filed on Feb. 6, 2015 and Japanese Patent Application (No. 2015-246998) filed on Dec. 18, 2015, the contents of which are incorporated herein by reference.

### BACKGROUND OF THE INVENTION

1. Field of the Invention The present invention relates to a display device for a vehicle.

2. Description of the Related Art

A meter device for a vehicle mounted in the vehicle has been known. The meter device for a vehicle includes a meter unit which has a vehicle information display area for displaying vehicle information such as a vehicle speed and an engine rotation speed. The vehicle further mounts an in-vehicle display used for a multimedia unit and a navigation system.

Mobile terminals such as a smartphone have been spread among people rapidly. The mobile terminal includes various kinds of functions such as a navigation function using GPS information, etc., an audio reproduction function for viewing a video image and listening to music and a browsing function for browsing webs provided on the internet. Such the mobile terminal is expected to be used in a vehicle as a matter of course. Thus, in order to improve convenience for an occupant of a vehicle, there has been also proposed a method in which the mobile terminal is connected to a device on the vehicle side and a display image of the mobile terminal is displayed on an in-vehicle display.

For example, JP-A-2012-124578 discloses an in-vehicle system which displays an image, being displayed on a display unit of a mobile phone, on a display unit of an in-vehicle device. Specifically, when the mobile phone is connected to the in-vehicle device, a control unit of the mobile phone reads image data representing an image being displayed on the display unit of the mobile phone from a memory and transfers the image data to the in-vehicle device via an interface. A control unit of the in-vehicle device receives the image data from the mobile phone via an interface, then performs an image processing using a memory and displays the image on the display unit of the in-vehicle device.

For example, JP-A-2012-111330 discloses a method of operating an icon on a mobile-phone side image displayed on a display unit of a vehicle in response to a switch operation of an operation unit (pointing device) provided at a center console of the vehicle.

In general, an operation with respect to a mobile terminal is performed by a touch operation on a display screen of the mobile terminal. Thus, even if the display screen of the mobile terminal is displayed on a display unit mounted on a vehicle, an operation of the display screen cannot be performed by an ordinary operation switch mounted on the vehicle.

### SUMMARY OF THE INVENTION

Therefore, the invention, having been contrived bearing in mind the heretofore described circumstances, has for its object to provide a display device for a vehicle which can perform operations substantially same as respective operations to be performed on a mobile terminal, by using an operation unit on the vehicle allowing an occupant of the vehicle to perform switch operations, while displaying on the display device for the vehicle an image to be displayed on a mobile display unit of the mobile terminal.

In order to solve this problem, the invention provides a display device for a vehicle includes: a connection unit configured to connect to a mobile terminal to communicate with the mobile terminal, the mobile terminal having a mobile display unit being capable of reading operation information based on a touch position, a touch direction, a touch timing or a combination thereof of an operation element with respect to a screen of the mobile display unit when a touch operation of the operation element is performed to the screen; a display unit configured to display a mobile display image to be displayed on the mobile display unit in a state where the mobile terminal is connected to the connection unit; a control unit configured to control display of the display unit; and an operation unit including a direction switch for performing a direction operation and a decision switch for performing a decision operation, and configured to input an operation instruction according to the direction operation or the decision operation to the control unit, wherein the control unit converts the operation instruction input from the operation unit into an operation signal corresponding to a touch operation for the mobile terminal and outputs the operation signal to the mobile terminal.

For example, the operation unit is a steering switch arranged at a steering wheel of the vehicle.

For example, the operation unit further includes a mode switch for switching among operation modes, and the operation modes include: a cursor mode for moving a cursor, which is displayed on the display unit so as to be superimposed on the mobile display image displayed on the display unit, in accordance with the direction operation of the direction switch; and a scroll mode for moving the mobile display image displayed on the display unit in accordance with the direction operation of the direction switch.

For example, in a case where the direction switch is operated in the scroll mode, the mobile display image displayed on the display unit moves gradually during a predetermined time in accordance with the direction operation of the direction switch.

For example, the mobile display image displayed on the display unit moves gradually during a constant time after the direction switch is operated in accordance with the direction operation of the direction switch.

For example, the mobile display image displayed on the display unit moves gradually during a period where the direction switch is operated, in accordance with the direction operation of the direction switch.

According to the invention, operations substantially same as respective touch operations to be performed on a mobile terminal can be performed on the mobile terminal by using an operation unit which allows an occupant of the vehicle to perform switch operations.

### BRIEF DESCRIPTION OF THE DRAWINGS

FIG. 1 is a block diagram schematically showing configuration of a meter device for a vehicle according to the first embodiment.

FIG. 2 is an explanatory diagram schematically showing configuration of a meter unit.

FIG. 3 is an explanatory diagram showing a display state of a meter display.

FIG. 4 is an explanatory diagram showing another display state of the meter display

FIG. 5 is an explanatory diagram for explaining a drawing processing performed by a graphic controller.

FIG. 6 is an explanatory diagram schematically showing configuration of an operation unit.

FIG. 7 is an explanatory diagram of an operation mode.

FIGS. 8A and 8B are explanatory diagrams of a focus mode.

FIG. 9 is an explanatory diagram showing an operable range of a cursor.

FIG. 10 is an explanatory diagram showing a correspondence relation between touch operations, operation modes and operations with respect to the operation unit.

FIG. 11 is an explanatory diagram showing concept of a coordinate conversion processing.

FIG. 12 is an explanatory diagram showing a marker for a scroll mode.

FIG. 13 is a flowchart illustrating a control processing for achieving a flick operation or a swipe operation by the operation unit.

### DETAILED DESCRIPTION OF THE EXEMPLARY EMBODIMENTS

### First Embodiment

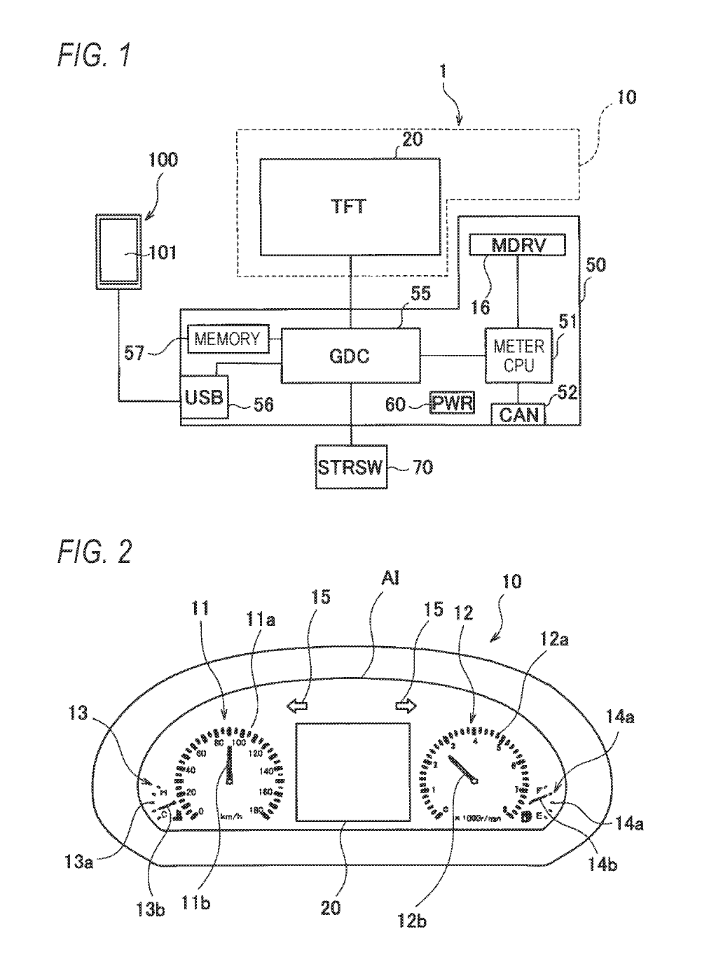

FIG. 1 is a block diagram schematically showing configuration of a meter device 1 for a vehicle according to the first embodiment. The vehicle meter device 1 mainly includes a meter unit (display unit) 10 and a control unit 50. In this embodiment, although the meter unit 10 and the control unit 50 are constituted separately, these units may be constituted integrally.

FIG. 2 is an explanatory diagram schematically showing configuration of the meter unit 10. The meter unit 10 is disposed, for example, at a dashboard in front of a driver's seat and displays vehicle information for an occupant of the vehicle. The vehicle information is information relating to the vehicle. In this embodiment, the vehicle information relates to information of a vehicle state. The vehicle state includes at least a vehicle speed and an engine rotation speed. In addition, the vehicle state includes a mileage, a shift position, direction indicators, time, various kinds of alarms, and so on.

The meter unit 10 includes a vehicle information display area Al for displaying the vehicle information. In the vehicle information display area AI, various kinds of meters, e.g., a speedometer 11 for displaying a vehicle seed, a tachometer 12 for displaying an engine rotation speed, and so on are arranged.

Each of the speedometer 11, the tachometer 12, a water temperature meter 13, a fuel meter 14a, 14b, direction indicators 15 and so on is an ordinary analog meter. Each of these meters is constituted of an arc-shaped scale 11a, 12a, 13a or 14a and an indicator 11b, 12b, 13b or 14b for indicating a required position on the scale.

In the vehicle information display area AI, a meter display 20 for displaying various kinds of information is further arranged. The meter display 20 displays time of a clock provided in the vehicle, an ambient temperature of the vehicle, the shift position, a travel distance, the various kinds of alarms, and other vehicle information. The meter display 20 further displays an image which is displayed on a mobile display unit 101 of a mobile terminal 100 described later, as the need arises.

In consideration of visibility from the driver's seat, the meter display 20 is disposed, for example, almost at the center of the vehicle information display area AI, that is, between the speedometer 11 and the tachometer 12. A TFT-LCD (Thin Film Transistor Liquid Crystal Display: an example of an LCD) can be used as the meter display 20. The meter display 20 has a screen size (almost 7 inches, for example) necessary for securing various kinds of display areas described later. The meter display 20 has a resolution substantially same as that of the mobile display unit 101 of the mobile terminal 100. Alternatively, in view of reduction of an operation load and a cost, the meter display may have a resolution lower than that of the mobile display unit 101 of the mobile terminal 100.

The control unit 50 controls display of the meter unit 10. The control unit includes a meter controller (meter CPU: meter Central Processing Unit) 51 for controlling an entirety of the meter unit 10, a graphic controller (GDC: Graphic Display Controller) 55 for controlling display of the meter display 20, a

CAN (Controller Area Network) communication unit 52, and a power supply unit (PWR) 60. The meter controller 51 and the graphic controller 55 are connected to each other so as to be capable of communication mutually.

The meter controller 51 transmits predetermined control data to the graphic controller 55 so as to display the vehicle information via the meter display 20. The graphic controller 55 performs a drawing processing in accordance with the control data.

The graphic controller 55 is mainly constituted of a microcomputer which includes a CPU, an ROM, an RAM and an I/O interface as main constituent elements. A memory 57 constituted of a semiconductor nonvolatile memory is connected to the graphic controller 55.

The graphic controller 55 performs the drawing processing in accordance with the control data transmitted from the meter controller 51. The graphic controller 55 outputs image data as a result of the drawing processing to the meter display 20, thus displaying a required image on the meter display 20.

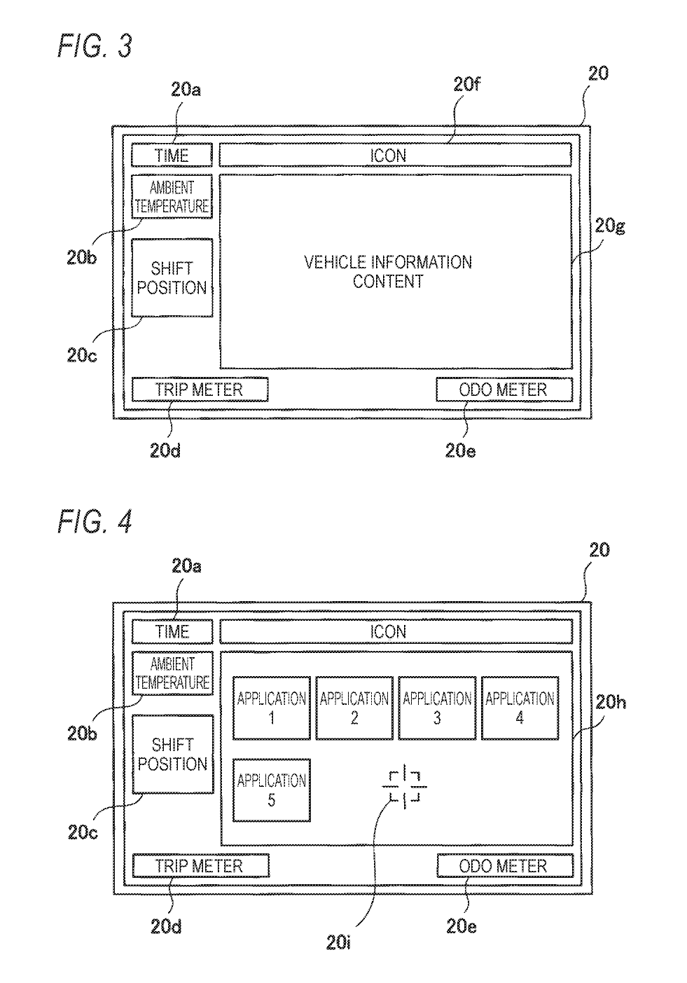

FIG. 3 is an explanatory diagram showing a display state of the meter display 20. In the meter display 20, a time area 20a displays time information of the clock provided in the vehicle, other areas 20b to 20f display ambient temperature information of the vehicle, shift position information, sectional travel distance information, mileage information and an icon representing a display menu, respectively, and a vehicle information content area 20g displays contents of other vehicle information. For example, the vehicle information content area 20g graphically displays an instantaneous fuel consumption, an average fuel consumption, a boost pressure, and so on, each together with a predetermined scale.

The graphic controller 55 is connected to a communication interface 56 which connects the vehicle meter device 1 to the mobile terminal 100 as to be capable of communication. The communication interface 56 is, for example, a wire communication interface. For example, an USB (Universal Serial Bus) is used as the communication interface. Alternatively, a radio communication interface may be used as the communication interface 56. For example, a near field radio communication such as Bluetooth (a registered trade mark) or a wireless LAN may be applied to the communication interface.

An example of the mobile terminal 100 is a smartphone. Alternatively, a mobile terminal such as a mobile phone or a PDA (Personal Digital Assistance) may be used as the mobile terminal. The mobile terminal 100 includes the mobile display unit 101 for displaying an image according to contents subjected to an information processing by the mobile terminal 100.

The mobile display unit 101 has a function of reading operation information based on a touch position, a touch direction, a touch timing or a combination thereof of a finger with respect to a screen of the mobile display unit 101. Specifically, the mobile display unit includes a touch panel allowing a touch operation by a user.

The touch operations are operations according to various kinds of touch modes such as a touch position, a touch direction and a touch timing of a finger (an operation element) with respect to a screen of the mobile display unit 101 (touch panel) when a touch operation of the finger is performed to the screen. The touch direction of the finger is defined as a direction of a touch locus of the finger with respect to the screen when the finger is touched to the screen. When the touch operation is performed, the mobile terminal 100 reads finger operation information of the touch operation, specifically, coordinate information of a position touched by a finger. Typical examples of the touch operation are a tap operation, a flick operation, a swipe operation, a pinch-in operation and a pinch-out operation. The tap operation is touching an optional position on the mobile display unit 101 by a fingertip. The flick operation is touching an optional position on the mobile display unit 101 by a fingertip and moving away the fingertip quickly therefrom. The swipe operation is touching an optional position on the mobile display unit 101 by a fingertip and sliding the fingertip therefrom. The pinch-out operation is sliding two fingers touched at respective optional positions on the mobile display unit 101 so as to spread a distance therebetween. The pinch-in operation is sliding two fingers touched at respective optional positions on the mobile display unit 101 so as to shorten a distance therebetween. The touch operations may be performed by an operation element such as a touch pen and a finger or fingers and so on. In the following explanation, the touch operations performed by the operation element are also contained in the touch operations performed by the finger or the fingers.

When a predetermined menu item (for example, “display of a mobile display screen” menu) is selected by an operation unit 70 after the mobile terminal 100 is connected to the communication interface 56 of the vehicle meter device 1, mobile image data is input to the graphic controller 55 from the mobile terminal 100. The mobile image data is image data representing a display image displayed on the mobile display unit 101 and is outputted from the mobile terminal 100 in response to a request from the graphic controller 55. The mobile image data is generated through a predetermined processing performed by the mobile terminal 100. That is, the mobile terminal performs an image processing on a display image (hereinafter referred to as “a mobile display image”) displayed on the mobile display unit 101 so as to cope with a resolution of the meter display 20 and a screen size of a mobile display image area 20h.

When the mobile image data is input to the graphic controller 55 from the mobile terminal 100, the graphic controller perfumes a drawing processing according to the mobile image data. The graphic controller 55 outputs required image data obtained by the drawing processing to the meter display 20, thus displaying the mobile display image on the meter display 20.

FIG. 4 is an explanatory diagram showing another display state of the meter display 20. The meter display 20 displays the mobile display image as well as the vehicle information. In the meter display 20, in place of the vehicle information content area 20g illustrated in FIG. 3, the mobile display image area 20h for displaying the mobile display image is set. In this manner, the meter display 20 simultaneously displays the vehicle information display area (an area including the display areas 20a to 20f) for displaying vehicle information and the mobile display image area 20h for displaying the mobile display image in a manner that the mobile display image area 20h is set separately from the vehicle information display area so as to be distinguished therefrom.

The meter display 20 also displays a cursor 20i which is movable on the display screen, displayed so as to match with display of the mobile display image, in correspondence to an operation instruction input from the operation unit 70 described later. The cursor 20i is not always displayed on the meter display 20 but displayed only when a cursor mode is set as an operation mode described later.

The mobile display image area 20h is not necessarily set to have the same size and layout as those of the vehicle information content area 20g but may employ an optional size and layout. However, the mobile display image area 20h is preferably set to have a size larger than a screen size of the mobile display unit 101 of the mobile terminal 100. By doing so, an occupant of the vehicle can view the mobile display image by the mobile display image area 20h having a screen size larger that of the mobile display unit 101 of the mobile terminal 100. Further, as the mobile display image area 20h has the larger size, an entirety of the mobile display image displayed on the mobile display unit 101 can be displayed in the mobile display image area without cutting out a part of the mobile display image.

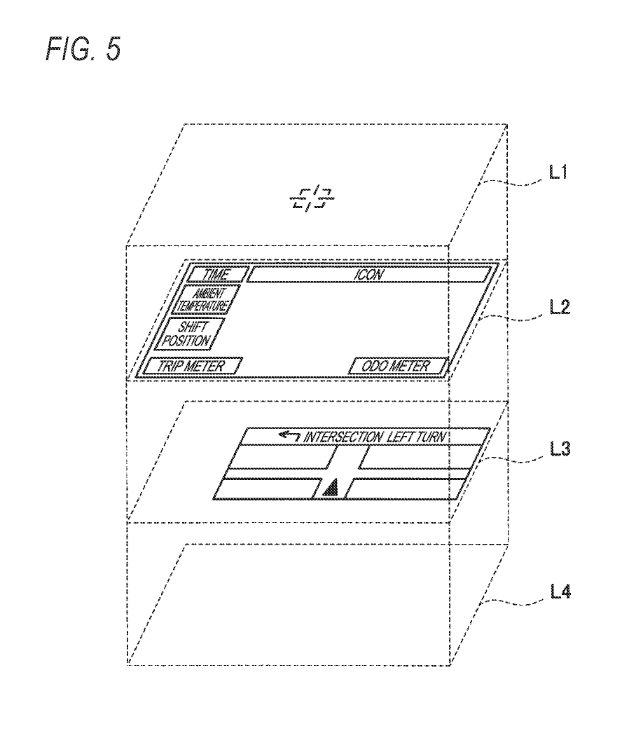

FIG. 5 is an explanatory diagram for explaining the drawing processing performed by the graphic controller 55. An image displayed on the meter display 20 is layered. The graphic controller 55 draws images of respective layers based on the control data outputted from the meter controller 51 and the mobile image data outputted from the mobile terminal 100, then prepares image data formed by superimposing images of at least one layer and outputs the image data thus prepared to the meter display 20.

In this embodiment, the number of the layers is four, and an image formed by superimposing images of four layers L1 to L4 from an uppermost layer to a lowermost layer is displayed on the mobile display image area 20h. The cursor 20i is drawn at the uppermost layer L1, the vehicle information is drawn at the second upper layer L2, the mobile display image is drawn at the third upper layer L3, and other information (for example, a photographed image in a case of connecting a camera) is drawn at the lowermost layer L4. In this manner, the graphic controller 55 provides the dedicated layer 3 for drawing the mobile display image, and draws the vehicle information at the layer 2 different from the layer 3. Further, in this embodiment, the cursor 20i is drawn at the layer L1 different from the layer 3 for drawing the mobile display image.

As illustrated in FIG. 4, in an image displayed on the meter display 20, if there is an image at a portion of the upper layer, this image of the upper layer is displayed at this portion. In contrast, if there is no image at a portion of the upper layer, an image of the lower layer is displayed at this portion. That is, an image of a layer with an upper level is displayed with higher priority. Incidentally, in place of this display method in which an image of the lower layer is not displayed due to the presence of an image of the upper layer, another display method may be employed in which a transmissivity of the upper layer is set to a suitable value so that an image of the lower layer is translucently displayed.

As one feature of this embodiment, the graphic controller 55 limits a drawing range (movable range) of the cursor 20i within a drawing range of the mobile display image, that is, the mobile display image area 20h. In other words, control specification of the cursor 20i is set so that the cursor 20i is displayed only within the mobile display image area 20h and not displayed outside this area.

In a case of moving the cursor 20i from an outer edge (for example, a left-side outer edge) of the mobile display image area 20h or a position near this edge to an outer edge on the opposite side (for example, a right-side outer edge) or a position near this edge, the cursor 20i is required to be moved over almost the entire range of the mobile display image area 20h. In this case, as it takes a time to move the cursor 20i and further an occupant of the vehicle has to perform a required operation continuously, convenience of the device degrades.

In view of this, in a state where the cursor 20i locates at the outer edge (for example, the left-side outer edge) of the mobile display image area 20h, if an operation instruction for moving the cursor 20i outside this outer edge (for example, left direction) is input, the graphic controller 55 preferably performs a loop processing. This loop processing is a processing of displaying the cursor 20i at the outer edge (for example, the right-side outer edge) of the mobile display image area 20h locating in opposite to the previous outer edge. By doing so, the cursor 20i can be moved efficiently within the mobile display image area 20h, and hence usability of the device can be improved.

As another feature of this embodiment, the graphic controller 55 converts an operation instruction input from the operation unit 70 into an operation signal corresponding to the touch operation and outputs the operation signal to the mobile terminal 100. In this respect, the operation signal after the conversion is equivalent to a simulated coordinate signal and corresponds to a coordinate signal recognized by the mobile terminal 100 when the touch operation is performed on the mobile display unit 101. As a precondition of this processing, operations with respect to the operation unit 70 are associated with the touch operations in advance, respectively. The graphic controller 55 performs such the conversion processing, thereby enabling to perform operations substantially same as the respective touch operations, with respect to the mobile terminal 100 through the operation unit 70 for switch operations.

The operation method of the mobile terminal 100 using the operation unit 70 will be described later.

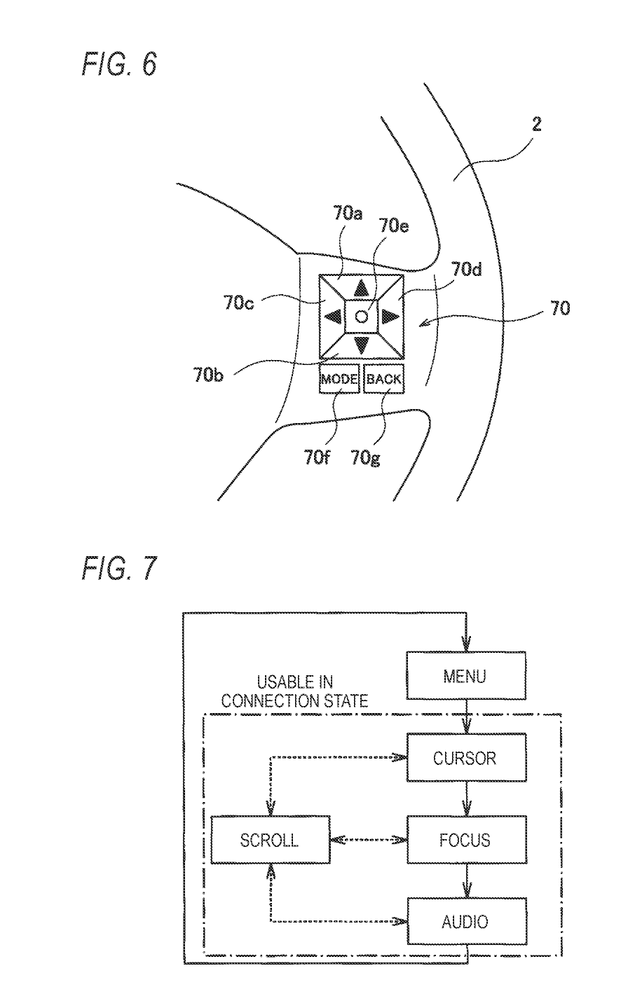

FIG. 6 is an explanatory diagram schematically showing configuration of the operation unit 70. The operation unit 70 is connected to the graphic controller 55. The operation unit 70 is used for inputting an operation instruction according to an operation performed by an occupant of the vehicle. The operation unit 70 is, for example, a steering switch (STRSW) provided at a steering wheel 2.

The operation unit 70 includes four direction switches, that is, upper, lower, left and right direction switches 70a, 70b, 70c and 70d, a decision switch 70e, a mode switch 70f, and a back switch 70g. Each of these switches 70a to 70g is designed to allow a switch operation (for example, a press operation) by an occupant of the vehicle.

Each of the four direction switches 70a, 70b, 70c and 70d serves to input an operation instruction relating to a moving direction of the cursor 20i displayed in an overlapped manner with the mobile display image displayed in the mobile display image area 20h, and also to input an operation instruction relating to a moving direction of the mobile display image displayed in the mobile display image area 20h. The decision switch 70e serves to input an operation instruction relating to decision of an occupant of the vehicle.

The mode switch 70f serves to input an operation instruction relating to switching of the operation mode. As illustrated in FIG. 7, a menu mode, a cursor mode, a focus mode, a scroll mode, an audio mode, etc., are prepared as the operation modes.

The menu mode is the operation mode for operating a menu item for switching the display contents of the vehicle information content area 20g and the mobile display image area 20h and an operation subject of the mobile terminal 100.

The cursor mode is the operation mode for moving the cursor 20i displayed in the mobile display image area 20h according to an operation of optional one of the four direction switches 70a, 70b, 70c and 70d so as to achieve the touch operation such as the tap operation, a double tap operation or a long tap operation.

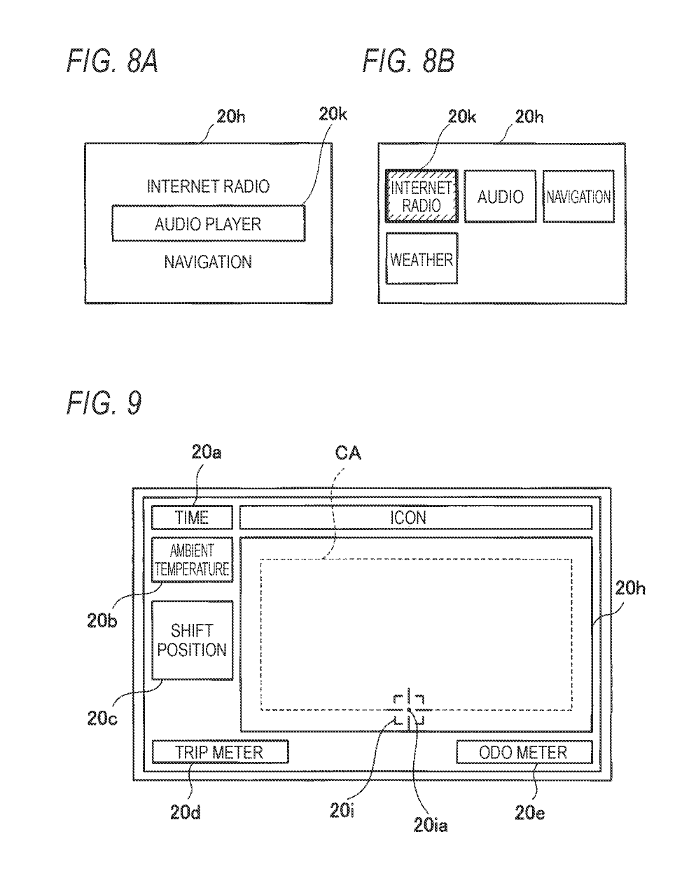

As illustrated in FIGS. 8A and 8B, the focus mode is the operation mode for moving a focus 20k displayed in the mobile display image area 20h according to an operation of optional one of the four direction switches 70a, 70b, 70c and 70d. For example, in this focus mode, based on application information obtained from the mobile terminal 100, an application screen displaying a list or icon of the application is displayed in the mobile display image area 20h and the focus 20k is displayed in a superimposed manner. Then, the list, the icon or the like within the application screen is designated and operated according to an operation of the focus 20k.

The scroll mode is the operation mode for moving the mobile display image displayed in the mobile display image area 20h according to an operation of optional one of the four direction switches 70a, 70b, 70c and 70d so as to achieve the touch operation such as the flip operation or the swipe operation.

The audio mode is the operation mode for reproducing music or video contained in the mobile terminal 100.

Each of these modes other than the menu mode can be used only in a state where the mobile terminal 100 is connected to the communication interface 56. The operation mode can be switched sequentially from the menu mode through the cursor mode, the focus mode and the audio mode each time the mode switch 70f is operated.

The back switch 70g serves to input an operation instruction for returning the mobile display image displayed in the mobile display image area 20h to an immediately preceding state.

According to the vehicle meter device 1 thus configured, in a state where the mobile terminal 100 is not connected to the communication interface 56 of the vehicle meter device 1, information relating to the vehicle information is displayed entirely in the vehicle information display area Al containing the meter display 20.

In this case, an occupant of the vehicle can switch the kind of the vehicle information to be displayed on the meter display 20 through the operation of the operation unit 70.

Next, an operation method of the mobile terminal 100 using the operation unit 70 will be explained as to a state where the mobile display image is displayed in the mobile display image area 20h.

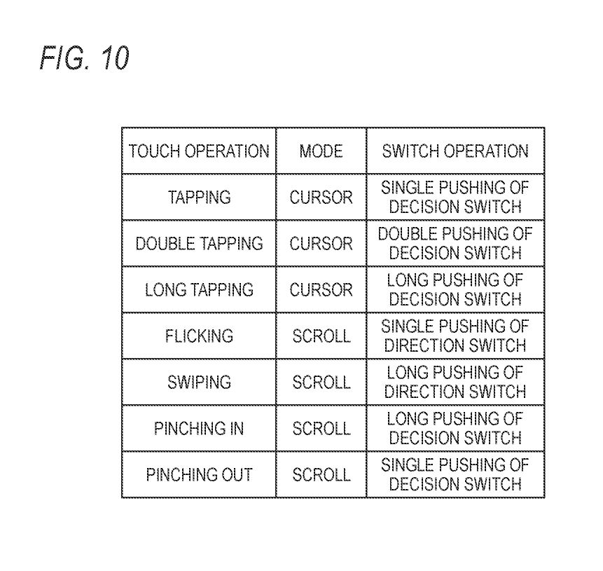

FIG. 10 is an explanatory diagram showing a correspondence relation between the touch operations, the operation modes and the operations with respect to the operation unit 70. For example, “tapping” as one of the touch operations corresponds to a single push operation of the decision switch 70e in the cursor mode. Similarly, “double tapping” as one of the touch operations corresponds to a double push operation of the decision switch 70e in the cursor mode. “Long tapping” as one of the touch operations corresponds to a long push operation of the decision switch 70e in the cursor mode. “Flicking” as one of the touch operations corresponds to a single push operation of one of the direction switches 70a to 70d in the scroll mode. “Swiping” as one of the touch operations corresponds to a long push operation of one of the direction switches 70a to 70d in the scroll mode. “Pinching in” as one of the touch operations corresponds to a single push operation of the decision switch 70e in the scroll mode. “Pinching out” as one of the touch operations corresponds to a long push operation of the decision switch 70e in the scroll mode. Such the correspondence relation is only one example, and other optional operations of the operation unit 70 may be associated with the touch operations.

Usually, the application utilizing the mobile terminal 100 is executed by tapping the application displayed on the mobile display unit 101. An occupant of the vehicle can select and operate the application installed in the mobile terminal 100 by selecting the cursor mode as the operation mode.

Hereinafter, an operation method of the mobile terminal 100 utilizing the cursor mode will be explained. As illustrated in FIG. 4, if the cursor 20i is displayed in the mobile display image area 20h in response to the selection of the cursor mode, an occupant of the vehicle selectively operates the direction switches 70a to 70d to move the cursor 20i, thus superimposing the center position of the cursor 20i on the desired application displayed in the mobile display image. Then, an occupant of the vehicle performs the single push operation of the decision switch 70e.

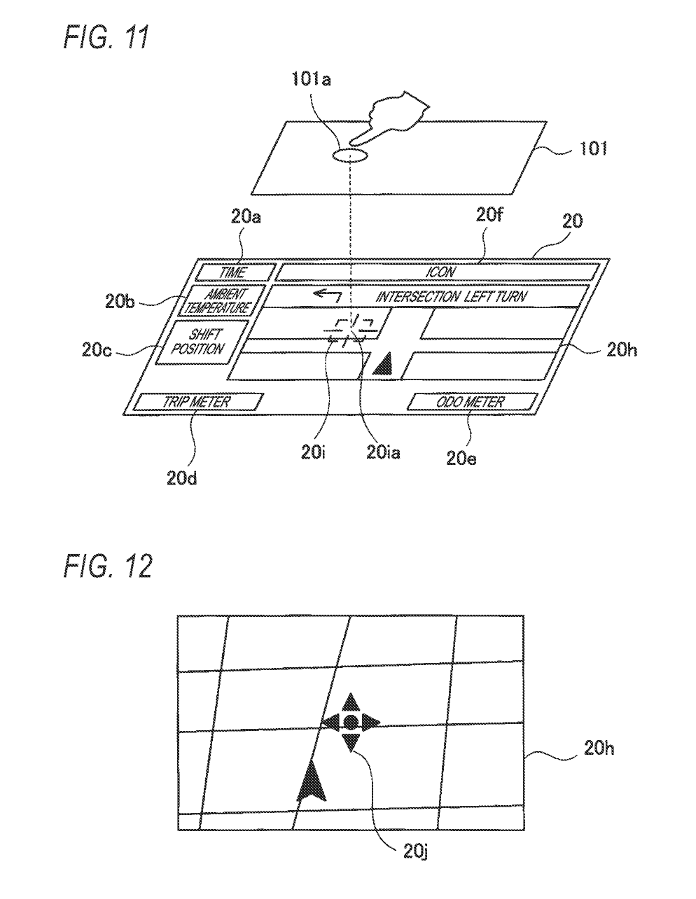

When the single push operation of the decision switch 70e is performed, the graphic controller 55 obtains a coordinate (center coordinate of the cursor 20i) where the center point 20ia of the cursor 20i locates, based on a two-dimensional coordinate set in the mobile display image area 20h in advance. As the coordinate system differs between the mobile display image area 20h and the mobile display unit 101, the graphic controller 55 performs a coordinate conversion processing based on the center coordinate of the cursor 20i. According to this coordinate conversion processing, as illustrated in FIG. 11, a coordinate (hereinafter referred to as “a corresponding coordinate”) 101a on the mobile display unit 101 positionally corresponding to the center point 20ia of the cursor 20i is specified. Then, the graphic controller 55 transmits the simulated touch operation signal (coordinate signal) based on the specified corresponding coordinate 101a to the mobile terminal 100.

In response to the reception of the simulated touch operation signal, the mobile terminal 100 recognizes that as if the tap operation is performed with respect to the corresponding coordinate 101a of the mobile display unit 101. As a result, the mobile terminal 100 executes the application corresponding to the tapped position on the mobile display unit.

Such the processing relating to the tap operation is also performed in the similar manner as to each of the double tap operation and the long tap operation.

Next, a switching processing of the operation mode will be explained. Firstly when the mode switch 70f is operated, the graphic controller 55 determines whether the operation is a single push operation or a long push operation based on an on-time of the mode switch 70f (that is, a time period during which the switch 70f is pushed).

In a case of the single push of the mode switch 70f, the graphic controller 55 sequentially switches the operation mode from one to another among the four modes, that is, the menu, cursor, focus and audio modes in response to every single pushing (see FIG. 7).

In a case of the long push of the mode switch 70f, the graphic controller 55 switches between the cursor mode and the scroll mode. As illustrated in FIG. 7, in response to the long push of the mode switch, the graphic controller can also switch between the focus mode and the scroll mode or between the audio mode and the scroll mode.

When the operation mode is switched to the scroll mode, the graphic controller 55 switches the cursor 20i displayed on the meter display 20 to a marker 20j for the scroll mode as illustrated in FIG. 12. Irrespective of the immediately preceding cursor position, a display position of the marker 20j is set so that a center coordinate of the marker 20j coincides with a center coordinate of the mobile display image area 20h. In the scroll mode, an image is shifted with reference to the position of the marker 20j. Thus, as the marker is disposed at the center of the mobile display image area initially, an image can be moved easily to an optional direction.

Next, an operation method utilizing the scroll mode will be explained. In a case of moving the mobile display image (for example, map information) displayed on the mobile display unit 101, usually, the flick operation or the swipe operation is performed on the mobile display unit 101. An occupant of the vehicle can move the mobile display image displayed in the mobile display image area 20h, utilizing the scroll mode.

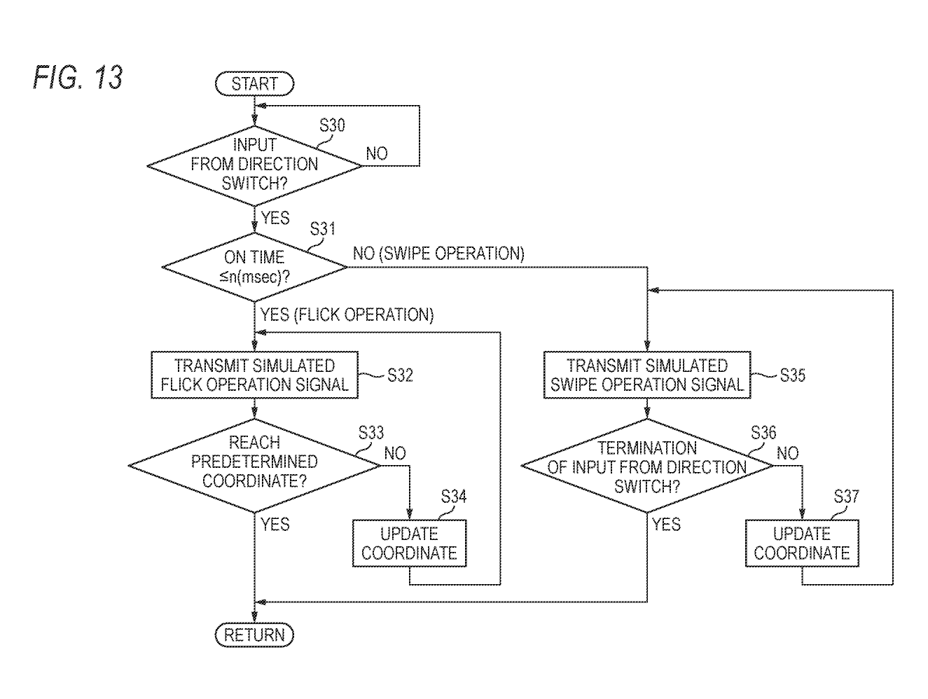

FIG. 13 is a flowchart illustrating a control processing for achieving the flick operation or the swipe operation. Firstly, in step 30 (S30), the graphic controller 55 determines whether or not the operation signal is input from one of the direction switches 70a to 70d. If one of the direction switches 70a to 70d is operated, an affirmative determination is made in step 30, and the processing proceeds to step 31 (S31).

In step 31, the graphic controller 55 determines whether or not an on-time of the one of the direction switches 70a to 70d, that is, a time period during which the one of the direction switches 70a to 70d is pushed is equal to or shorter than a determination value n (msec). The determination value n is set so as to distinguish between the single push operation and the long push operation.

If the operation on the one of the direction switches 70a to 70d is the single pushing (flick operation), the on-time is equal to or shorter than the determination value n. Thus, an affirmative determination is made in step 31, and the processing proceeds to step 32 (S32). In contrast, if the operation on the one of the direction switches 70a to 70d is the long pushing (swipe operation), the on-time is longer than the determination value n. Thus, a negative determination is made in step 31, and the processing proceeds to step 35 (S35).

In step 32, the graphic controller 55 transmits a simulated flick operation signal to the mobile terminal 100. Specifically, firstly the graphic controller 55 specifies an objective coordinate. In a case of executing the processing of step 32 for the first time by operating one of the direction switches 70a to 70d, the center coordinate of the marker 20j in the mobile display image area 20h is used as the objective coordinate. In contrast, in the succeeding case, an objective coordinate updated by step 34 (S34) described later is used as the objective coordinate.

Next, the graphic controller 55 performs the coordinate conversion processing based on the objective coordinate. According to the coordinate conversion processing, a coordinate (corresponding coordinate) on the mobile display unit 101 positionally corresponding to the objective coordinate of the mobile display image area 20h is specified. Then, the graphic controller 55 transmits the simulated flick operation signal (coordinate signal) based on the specified corresponding coordinate to the mobile terminal 100.

In step 33 (S33), the graphic controller 55 determines whether or not the objective coordinate reaches a predetermined end coordinate. The end coordinate is set according to a moving amount of an image caused by the flick operation. For example, the end coordinate can be set at a position corresponding to a half size of the mobile display image area 20h. For example, in a case of reproducing in a simulated manner the flick operation of quickly moving a finger to the left direction, a coordinate at the center of the left end side of the mobile display image area 20h corresponds to the end coordinate. Also, for example, in a case of reproducing in a simulated manner the flick operation of quickly moving a finger to the upper direction, a coordinate at the center of the upper end side of the mobile display image area 20h corresponds to the end coordinate.

When the objective coordinate reaches the end coordinate, an affirmative determination is made in step 33, and the control processing terminates. In contrast, when the objective coordinate does not reach the end coordinate, a negative determination is made in step 33, and the processing proceeds to step 34 (S34).

In step 34, the graphic controller 55 performs a coordinate update processing. In this coordinate update processing, the graphic controller 55 updates the objective coordinate to a position shifted from the current position by a predetermined amount according to the operation direction of one of the direction switches 70a to 70d. For example, when the left direction switch 70c is operated, the objective coordinate is updated to a position shifted to the left direction from the current position by the predetermined amount. The shift amount can be determined by an initial setting or a manual setting by an occupant of the vehicle.

When the processing from step 32 to step 34 is continued for a constant time, the simulated flick signal is input continuously to the mobile terminal 100. Thus, the mobile terminal 100 obtains continuously-changing coordinate information like a case where the flick operation is performed on the mobile display unit 101. As a result, the mobile terminal 100 recognizes that as if the flip operation is performed on the mobile display unit 101 according to the movement of the corresponding coordinate. Then, the mobile terminal 100 gradually shifts the coordinate of the image displayed at the center of the mobile display unit 101 to a direction opposite the flick operation direction. By doing so, the mobile display image gradually moves, on the mobile display unit 101 and in the mobile display image area 20h, in correspondence to the operation direction of the one of direction switches 70a to 70d during a constant time after the operation of the one of direction switches 70a to 70d. The general flick operation employs a display mode in which a moving speed of an image is not constant but changes with time. For example, the moving speed of an image is high at first and then becomes lower with time. In view of this, the shift amount of the coordinate of an image is not necessarily constant but may be changed with time.

In step 35, the graphic controller 55 transmits a simulated swipe operation signal to the mobile terminal 100. Specifically, firstly the graphic controller 55 specifies an objective coordinate. In a case of executing the processing of step 35 for the first time by operating one of the direction switches 70a to 70d, the center coordinate of the marker 20j in the mobile display image area 20h is used as the objective coordinate. In contrast, in the succeeding case, an objective coordinate updated by step 37 (S37) described later is used as the objective coordinate.

Next, the graphic controller 55 performs the coordinate conversion processing based on the objective coordinate. According to the coordinate conversion processing, a coordinate (corresponding coordinate) on the mobile display unit 101 positionally corresponding to the objective coordinate of the mobile display image area 20h is specified. Then, the graphic controller 55 transmits the simulated swipe operation signal (coordinate signal) based on the specified corresponding coordinate to the mobile terminal 100.

In step 36 (S36), the graphic controller 55 determines whether or not the operation signal from the direction switches 70a to 70d terminates. When an operation of the one of direction switches 70a to 70d is stopped, the operation signal from the one of direction switches 70a to 70d terminates. Thus, an affirmative determination is made in step 36, and the control processing terminates. In contrast, when an operation of the one of direction switches 70a to 70d is continued, a negative determination is made in step 36, and the processing proceeds to step 37 (S37).

In step 37, the graphic controller 55 performs a coordinate update processing. In this coordinate update processing, the graphic controller 55 updates the objective coordinate to a position shifted from the current position by a predetermined amount according to the operation direction of one of the direction switches 70a to 70d. For example, when the left direction switch 70c is operated, the objective coordinate is updated to a position shifted to the left direction from the current position by the predetermined amount. The shift amount can be determined by an initial setting or a manual setting by an occupant of the vehicle. When the objective coordinate reaches the coordinate at the end of the mobile display image area 20h, the center coordinate of the mobile display image area 20h is set as the objective coordinate in the next coordinate update processing. Then, the coordinate update processing is repeated from this center coordinate.

When the processing from step 35 to step 37 is continued for an operation period of the one of direction switches 70a to 70d, the simulated swipe signal is input continuously to the mobile terminal 100. Thus, the mobile terminal 100 obtains continuously-changing coordinate information like a case where the swipe operation is performed on the mobile display unit 101. As a result, the mobile terminal 100 recognizes that as if the swipe operation is performed on the mobile display unit 101 according to the movement of the corresponding coordinate. Then, the mobile terminal 100 gradually shifts the coordinate of the image displayed at the center of the mobile display unit 101 to a direction opposite the swipe operation direction. By doing so, the mobile display image gradually moves, on the mobile display unit 101 and in the mobile display image area 20h, in correspondence to the operation direction of the one of direction switches 70a to 70d during a period where the one of direction switches 70a to 70d is operated.

In this manner, according to the embodiment, the vehicle meter device 1 includes the communication interface 56 which is connectable to the mobile terminal 100 having the mobile display unit 101 capable of performing the touch operation so that the communication interface can communicate with the mobile terminal; the meter display 20 (mobile display image area 20h) for displaying the mobile display image to be displayed on the mobile display unit 101 in a state where the mobile terminal 100 is connected to the communication interface 56; the control unit 50 for controlling display of the meter display 20; and the operation unit 70 which includes the direction switches 70a to 70d for performing the respective direction operations and the decision switch 70e for performing the decision operation and inputs the operation instruction according to the switch operation of an occupant of the vehicle to the control unit 50. The control unit 50 converts the operation instruction input from the operation unit 70 into the operation signal corresponding to the touch operation and outputs the operation signal to the mobile terminal 100.

According to this configuration, as the mobile display image is displayed at the part of the vehicle information display area Al of the meter unit 10, an occupant of the vehicle can view the mobile display image via the meter unit 10. In general, as the vehicle meter device 1 is mounted in a vehicle as a device for displaying the vehicle information, the vehicle meter device 1 can display an image of the mobile terminal 100 so long as the meter device mounts predetermined functions. Further, as the vehicle meter device 1 is disposed at a position excellent in visibility for an occupant of the vehicle, in particular, a driver, a moving amount of a line of sight is shorter as compared with a case of displaying on an in-vehicle display. Thus, visibility of the mobile display image can be improved. As a result, as it is not necessary for a driver to directly view the mobile terminal 100, the driver can be suppressed from being disturbed in concentration on driving.

Some of display units on vehicle sides include touch panels utilized for multimedia units and navigation systems. In this case, the mobile terminal 100 may be operated by the touch panel. However, based on a position of a touch operation perfumed on the display unit (touch panel) on a vehicle side, it is necessary to specify a display object, thus operated, which is displayed on the mobile terminal. Thus, it is required to install a dedicated application common to both the vehicle and the mobile terminal and to make a control event associate between the vehicle and the mobile terminal. As a result, although the dedicated application can be used on the vehicle side, usual application installed in only the mobile terminal cannot be used on the vehicle side, disadvantageously.

In a case where the display unit on the vehicle side is not disposed at a position operable by an occupant of the vehicle, the occupant cannot perform a touch operation irrespective of presence or absence of a touch panel, disadvantageously.

The display object may be operated by a cursor or a focus interlocking with a touch operation of the operation unit. However, as described above, as it is necessary to specify a display object, having been operated, which is displayed on the mobile terminal, common dedicated application is required to be installed in each of the vehicle and the mobile terminal.

In this respect, according to the configuration of this embodiment, an occupant of the vehicle can perform an operation substantially same as the touch operation with respect to the mobile terminal 100 via the operation unit 70 which allows the switch operation by the occupant. In particular, according to this embodiment, the control unit converts an operation instruction input from the operation unit 70 into an operation signal corresponding to a touch operation, specifically, a simulated coordinate signal corresponding to the touch operation and outputs the simulated coordinate signal. Thus, the mobile terminal 100 recognizes via the simulated coordinate signal that as if the tap operation is performed on the mobile display unit 101. As a result, as it is not necessary to specify a display object having been operated based on an operation position in the mobile display image area 20h on the vehicle side, common dedicated application is not required to be installed in each of the vehicle and the mobile terminal. In this manner, the application installed in the mobile terminal 100 can be operated freely.

In this embodiment, as the mobile display image is displayed in the vehicle meter device 1, the touch operation cannot be performed directly on this image. However, according to this embodiment, as the mobile display image can be operated using the operation unit 70 allowing the switch operation, the display and operation of the mobile display image on the vehicle meter device 1 can be achieved.

In this embodiment, the operation unit 70 is a steering switch arranged at the steering wheel 2 of the vehicle.

According to this configuration, a driver can easily operate the operation unit 70.

Further, in this embodiment, the operation unit 70 further includes the mode switch 70f for switching the operation mode. The operation modes include the cursor mode for moving the cursor 20i, disposed in a superimposed manner on the mobile display image displayed on the meter display 20, according to an operation of optional one of the direction switches 70a to 70d, and the scroll mode for moving the mobile display image displayed on the meter display 20 according to an operation of optional one of the direction switches 70a to 70d.

This configuration provides the mode for operating the cursor 20i used for selecting a display object and the mode for moving the mobile display image. These modes can be selected freely according to an operation of the mode switch 70f. Thus, variety of the operations can be achieved by using the operation unit 70 having a limited number of the switches.

In this embodiment, the operations of the switches 70a to 70g of the operation unit 70 are associated with the cursor mode and the scroll mode. However, the operations of the switches 70a to 70g of the operation unit 70 may be associated with the menu mode or the audio mode. For example, in the audio mode, “reproduction” of a medium may be performed in response to a single push operation of the right direction switch 70d.

Although the vehicle meter device according to the embodiment of the invention is explained above, the invention is not limited to this embodiment but, of course, may be modified in various manners within a range of the invention. For example, the vehicle information within the meter display and the display mode and layout of the mobile display image may be set individually according to design of the meter unit. Further, in this embodiment, in a case of displaying the vehicle information, a part of the information is displayed using the analog meters. Alternatively, an entirety of the vehicle information display area may be constituted of a display so that display contents of each of the various kinds of meters and meter display is displayed using a graphic processing.

Although the embodiment is explained as to a case where the invention is applied to the vehicle meter device, the invention can be widely applied to a display device for a vehicle mounted in a vehicle, such as a display or headup display for a navigation system or multimedia. In this case, the vehicle information may contain vehicle travel information containing map information for route guidance and vehicle periphery and route guidance information, as well as information of the vehicle state.

Further, in this embodiment, although the switches are individually provided for the respective functions (direction, decision, mode and back), the invention is not limited thereto but only a single switch may be provided so as to be configured to cope with these functions.

What is claimed is:

1. A display device for a vehicle, comprising:
a connection unit configured to connect to a mobile terminal to communicate with the mobile terminal, the mobile terminal having a mobile display unit being capable of reading operation information based on a touch position, a touch direction, a touch timing or a combination thereof of an operation element with respect to a screen of the mobile display unit when a touch operation of the operation element is performed to the screen;
a display unit configured to display a mobile display image to be displayed on the mobile display unit in a state where the mobile terminal is connected to the connection unit;
a control unit configured to control display of the display unit; and
an operation unit including a direction switch for performing a direction operation and a decision switch for performing a decision operation, and configured to input an operation instruction according to the direction operation or the decision operation to the control unit,
wherein the control unit converts the operation instruction input from the operation unit into an operation signal corresponding to a touch operation for the mobile terminal and outputs the operation signal to the mobile terminal.

2. The display device according to claim 1, wherein the operation unit is a steering switch arranged at a steering wheel of the vehicle.

3. The display device according to claim 1, wherein the operation unit further includes a mode switch for switching among operation modes; and
wherein the operation modes include:
a cursor mode for moving a cursor, which is displayed on the display unit so as to be superimposed on the mobile display image displayed on the display unit, in accordance with the direction operation of the direction switch; and
a scroll mode for moving the mobile display image displayed on the display unit in accordance with the direction operation of the direction switch.

4. The display device according to claim 3, wherein in a case where the direction switch is operated in the scroll mode, the mobile display image displayed on the display unit moves gradually during a predetermined time in accordance with the direction operation of the direction switch.

5. The display device according to claim 4, wherein the mobile display image displayed on the display unit moves gradually during a constant time after the direction switch is operated in accordance with the direction operation of the direction switch.

6. The display device according to claim 4, wherein the mobile display image displayed on the display unit moves gradually during a period where the direction switch is operated, in accordance with the direction operation of the direction switch.
